(19) United States
(12) Patent Application Publication
(10) Pub. No.: US 2025/0106867 A1
(43) Pub. Date: Mar. 27, 2025

(54) METHOD AND APPARATUS FOR TCI STATE DEACTIVATION AND ACTIVATION

(71) Applicant: Nokia Technologies Oy, Espoo (FI)

(72) Inventors: Timo KOSKELA, Oulu (FI); Riikka Karoliina DIMNIK, Espoo (FI); Jani-Pekka KAINULAINEN, Cambridge (GB); Lars DALSGAARD, Oulu (FI); Sanjay GOYAL, Murray Hill, NJ (US); Samuli Heikki TURTINEN, Oulu (FI)

(21) Appl. No.: 18/891,173

(22) Filed: Sep. 20, 2024

Related U.S. Application Data
(60) Provisional application No. 63/540,470, filed on Sep. 26, 2023.

(51) Int. Cl. H04W 72/231; H04L 5/00

(52) U.S. Cl. CPC H04W 72/231; H04L 5/0091

(57) ABSTRACT

A user equipment (UE) may receive, from a network entity, a configuration of one or more candidate cells for switching to from a serving cell. The UE may receive, from the network entity, an indication to deactivate all transmission configuration indicator (TCI) states associated with one or more indicated cells. The UE may deactivate the all TCI states associated with the one or more indicated cells based at least in part on receiving the indication to deactivate the all TCI states. One or more of the one or more candidate cells or the serving cell may include the one or more indicated cells.

### TECHNOLOGICAL FIELD

An example embodiment relates generally to wireless communications and, more particularly, but not exclusively, to a method, apparatus and computer program product for transmission configuration indicator state deactivation and activation.

### BACKGROUND

Some wireless devices may be configured to communicate using one or more transmission configuration indicator (TCI) states. For example, a user equipment (UE) may be configured with a list of TCI states for decoding physical downlink shared channel (PDSCH) communications. The UE may then utilize one or more TCI states from the list of TCI states to decode communications of the PDSCH. Each TCI state may include one or more parameters for configuring a quasi-colocation (QCL) relationship for downlink reference signaling and demodulation reference signal portions of the PDSCH. When a UE is configured with or otherwise activates one or more TCI states, the UE may perform one or more operations that consume resources. For example, the UE may perform operations associated with reference signaling for each active TCI state. In some cases, however, a UE may not utilize one or more activated TCI states for communications, but the UE may continue to perform the one or more operations that consume resources, which may be undesirable.

### BRIEF SUMMARY

In one aspect a method includes receiving, by a user equipment (UE) and from a network entity, a configuration of one or more candidate cells for switching to from a serving cell; receiving, by the UE and from the network entity, an indication to deactivate all transmission configuration indicator (TCI) states associated with one or more indicated cells; and deactivating, by the UE, the all TCI states associated with the one or more indicated cells based at least in part on receiving the indication to deactivate the all TCI states.

In one embodiment, one or more of: (i) the one or more candidate cells or (ii) the serving cell comprise the one or more indicated cells. In one embodiment, the method includes activating, by the UE, one or more TCI states associated with a candidate cell of the one or more candidate cells based at least in part on receiving a command; switching from the serving cell to the candidate cell of the one or more candidate cells; and causing transmission, by the UE, of one or more messages using the one or more activated TCI states associated with the candidate cell. In one embodiment, receiving the indication to deactivate the all TCI states comprises: receiving a bitmap comprising a plurality of bits corresponding to the one or more indicated cells, wherein a bit of the plurality of bits indicates that the UE is to deactivate the all TCI states associated with a respective cell of the one or more indicated cells.

In one embodiment, receiving the indication to deactivate all TCI states comprises: receiving a medium access control control element comprising a bit for activating one or more TCI states or deactivating the all TCI states associated with the one or more indicated cells. In one embodiment, a quantity of octets in the medium access control control element is determined based at least in part on a value of the bit. In one embodiment, the method includes determining, by the UE, whether to read one or more octets of the medium access control control element based at least in part on a value of the bit. In one embodiment, the bit is further configured to activate one or more TCI states or deactivate the all TCI states, wherein a cell identifier field of the medium access control control element indicates the one or more indicated cells.

In one embodiment, receiving the indication to deactivate the all TCI states comprises: receiving a medium access control control element comprising a logical channel identifier field for deactivating the all TCI states. In one embodiment, receiving the indication to deactivate the all TCI states comprises: receiving a medium access control control element comprising the indication to deactivate the all TCI states and an indication to activate one or more TCI states associated with a candidate cell of the one or more candidate cells. In one embodiment, receiving the indication to deactivate the all TCI states comprises: receiving a medium access control control element comprising (i) a plurality of bits that indicate a plurality of cell identifiers and (ii) a plurality of bits that indicate whether respective previously activated TCI states are activated or deactivated.

In one embodiment, receiving the indication to deactivate the all TCI states comprises: receiving a medium access control control element that activates one or more TCI states associated with a candidate cell of the one or more candidate cells, wherein the UE deactivates all TCI states of one or more candidate cells not indicated by the medium access control control element. In one embodiment, a bit of the medium access control control element indicates that previously activated TCI states are to be deactivated by the UE. In one embodiment, receiving the indication to deactivate the all TCI states comprises: receiving an indication of a beam for a candidate cell of the one or more candidate cells. In one embodiment, the method includes refraining from performing one or more operations associated with the all TCI states based at least in part on the deactivating. In one embodiment, the all TCI states are associated with cell switching from the serving cell to a candidate cell of the one or more candidate cells.

In one aspect, a method includes causing transmission, by a network entity and towards a UE, of a configuration of one or more candidate cells for the UE to switch to from a serving cell; and causing transmission, by the network entity and towards the UE, of an indication to deactivate all TCI states associated with one or more indicated cells based at least in part on causing transmission of the configuration of the one or more candidate cells. In one embodiment, one or more of: (i) the one or more candidate cells or (ii) the serving cell comprise the one or more indicated cells.

In one embodiment, the method includes receiving, from the UE, one or more messages using one or more TCI states associated with a candidate cell of the one or more candidate cells. In one embodiment, the method includes receiving, from the UE, one or more messages using one or more TCI states associated with the serving cell. In one embodiment, causing transmission of the indication to deactivate the all TCI states comprises: causing transmission of a bitmap comprising a plurality of bits corresponding to the one or more indicated cells, wherein a bit of the plurality of bits indicates that the UE is to deactivate the all TCI states associated with a respective cell of the one or more indicated cells.

In one embodiment, causing transmission of the indication to deactivate all TCI states comprises: causing transmission of a medium access control control element comprising a bit for activating one or more TCI states or deactivating the all TCI states associated with the one or more indicated cells. In one embodiment, a quantity of octets in the medium access control control element is determined based at least in part on a value of the bit. In one embodiment, the bit is further configured to activate one or more TCI states or deactivate the all TCI states, wherein a cell identifier field of the medium access control control element indicates the one or more indicated cells.

In one embodiment, causing transmission of the indication to deactivate the all TCI states comprises: causing transmission of a medium access control control element comprising a logical channel identifier field for deactivating the all TCI states. In one embodiment, causing transmission of the indication to deactivate the all TCI states comprises: causing transmission of a medium access control control element comprising the indication to deactivate the all TCI states and an indication to activate one or more TCI states associated with a candidate cell of the one or more candidate cells. In one embodiment, causing transmission of the indication to deactivate the all TCI states comprises: causing transmission of a medium access control control element comprising (i) a plurality of bits that indicate a plurality of cell identifiers and (ii) a plurality of bits that indicate whether respective previously activated TCI states are activated or deactivated.

In one embodiment, causing transmission of the indication to deactivate the all TCI states comprises: causing transmission of a medium access control control element that activates one or more TCI states associated with a candidate cell of the one or more candidate cells, wherein the UE deactivates all TCI states of one or more candidate cells not indicated by the medium access control control element. In one embodiment, a bit of the medium access control control element indicates that previously activated TCI states are to be deactivated by the UE. In one embodiment, causing transmission of the indication to deactivate the all TCI states comprises: causing transmission of an indication of a beam for a candidate cell of the one or more candidate cells. In one embodiment, the all TCI states are associated with cell switching from the serving cell to a candidate cell of the one or more candidate cells.

In one aspect a computing apparatus includes a processor. The computing apparatus also includes a memory storing instructions that, when executed by the processor, configure the apparatus to receive, by a UE and from a network entity, a configuration of one or more candidate cells for switching to from a serving cell; receive, by the UE and from the network entity, an indication to deactivate all TCI states associated with one or more indicated cells; and deactivate, by the UE, the all TCI states associated with the one or more indicated cells based at least in part on receiving the indication to deactivate the all TCI states.

In one embodiment, one or more of: (i) the one or more candidate cells or (ii) the serving cell comprise the one or more indicated cells. In one embodiment, the instructions further configure the apparatus to activate, by the UE, one or more TCI states associated with a candidate cell of the one or more candidate cells based at least in part on receiving a command; switch from the serving cell to the candidate cell of the one or more candidate cells; and cause transmission, by the UE, of one or more messages using the one or more activated TCI states associated with the candidate cell. In one embodiment, receiving the indication to deactivate the all TCI states comprises: receiving a bitmap comprising a plurality of bits corresponding to the one or more indicated cells, wherein a bit of the plurality of bits indicates that the UE is to deactivate the all TCI states associated with a respective cell of the one or more indicated cells.

In one embodiment, receiving the indication to deactivate all TCI states comprises: receiving a medium access control control element comprising a bit for activating one or more TCI states or deactivating the all TCI states associated with the one or more indicated cells. In one embodiment, a quantity of octets in the medium access control control element is determined based at least in part on a value of the bit. In one embodiment, the instructions further configure the apparatus to determine, by the UE, whether to read one or more octets of the medium access control control element based at least in part on a value of the bit. In one embodiment, the bit is further configured to activate one or more TCI states or deactivate the all TCI states, wherein a cell identifier field of the medium access control control element indicates the one or more indicated cells.

In one embodiment, receiving the indication to deactivate the all TCI states comprises: receiving a medium access control control element comprising a logical channel identifier field for deactivating the all TCI states. In one embodiment, receiving the indication to deactivate the all TCI states comprises: receiving a medium access control control element comprising the indication to deactivate the all TCI states and an indication to activate one or more TCI states associated with a candidate cell of the one or more candidate cells. In one embodiment, receiving the indication to deactivate the all TCI states comprises: receiving a medium access control control element comprising (i) a plurality of bits that indicate a plurality of cell identifiers and (ii) a plurality of bits that indicate whether respective previously activated TCI states are activated or deactivated.

In one embodiment, receiving the indication to deactivate the all TCI states comprises: receiving a medium access control control element that activates one or more TCI states associated with a candidate cell of the one or more candidate cells, wherein the UE deactivates all TCI states of one or more candidate cells not indicated by the medium access control control element. In one embodiment, a bit of the medium access control control element indicates that previously activated TCI states are to be deactivated by the UE. In one embodiment, receiving the indication to deactivate the all TCI states comprises: receiving an indication of a beam for a candidate cell of the one or more candidate cells. In one embodiment, the instructions further configure the apparatus to refrain from performing one or more operations associated with the all TCI states based at least in part on the deactivating. In one embodiment, the all TCI states are associated with cell switching from the serving cell to a candidate cell of the one or more candidate cells.

In one aspect a computing apparatus includes a processor. The computing apparatus also includes a memory storing instructions that, when executed by the processor, configure the apparatus to cause transmission, by a network entity and towards a UE, of a configuration of one or more candidate cells for the UE to switch to from a serving cell; and cause transmission, by the network entity and towards the UE, of an indication to deactivate all TCI states associated with one or more indicated cells based at least in part on causing transmission of the configuration of the one or more candidate cells. In one embodiment, one or more of: (i) the one or more candidate cells or (ii) the serving cell comprise the one or more indicated cells.

In one embodiment, the instructions further configure the apparatus to receive, from the UE, one or more messages using one or more TCI states associated with a candidate cell of the one or more candidate cells. In one embodiment, the instructions further configure the apparatus to receive, from the UE, one or more messages using one or more TCI states associated with the serving cell. In one embodiment, causing transmission of the indication to deactivate the all TCI states comprises: causing transmission of a bitmap comprising a plurality of bits corresponding to the one or more indicated cells, wherein a bit of the plurality of bits indicates that the UE is to deactivate the all TCI states associated with a respective cell of the one or more indicated cells.

In one embodiment, causing transmission of the indication to deactivate all TCI states comprises: causing transmission of a medium access control control element comprising a bit for activating one or more TCI states or deactivating the all TCI states associated with the one or more indicated cells. In one embodiment, a quantity of octets in the medium access control control element is determined based at least in part on a value of the bit. In one embodiment, the bit is further configured to activate one or more TCI states or deactivate the all TCI states, wherein a cell identifier field of the medium access control control element indicates the one or more indicated cells.

In one embodiment, causing transmission of the indication to deactivate the all TCI states comprises: causing transmission of a medium access control control element comprising a logical channel identifier field for deactivating the all TCI states. In one embodiment, causing transmission of the indication to deactivate the all TCI states comprises: causing transmission of a medium access control control element comprising the indication to deactivate the all TCI states and an indication to activate one or more TCI states associated with a candidate cell of the one or more candidate cells. In one embodiment, causing transmission of the indication to deactivate the all TCI states comprises: causing transmission of a medium access control control element comprising (i) a plurality of bits that indicate a plurality of cell identifiers and (ii) a plurality of bits that indicate whether respective previously activated TCI states are activated or deactivated.

In one embodiment, causing transmission of the indication to deactivate the all TCI states comprises: causing transmission of a medium access control control element that activates one or more TCI states associated with a candidate cell of the one or more candidate cells, wherein the UE deactivates all TCI states of one or more candidate cells not indicated by the medium access control control element. In one embodiment, a bit of the medium access control control element indicates that previously activated TCI states are to be deactivated by the UE. In one embodiment, causing transmission of the indication to deactivate the all TCI states comprises: causing transmission of an indication of a beam for a candidate cell of the one or more candidate cells. In one embodiment, the all TCI states are associated with cell switching from the serving cell to a candidate cell of the one or more candidate cells.

In one aspect a non-transitory computer-readable storage medium includes instructions that, when executed by a computer, cause the computer to receive, by a UE and from a network entity, a configuration of one or more candidate cells for switching to from a serving cell; receive, by the UE and from the network entity, an indication to deactivate all TCI states associated with one or more indicated cells; and deactivate, by the UE, the all TCI states associated with the one or more indicated cells based at least in part on receiving the indication to deactivate the all TCI states.

In one embodiment, one or more of: (i) the one or more candidate cells or (ii) the serving cell comprise the one or more indicated cells. In one embodiment, the instructions further configure the computer to activate, by the UE, one or more TCI states associated with a candidate cell of the one or more candidate cells based at least in part on receiving a command; switch from the serving cell to the candidate cell of the one or more candidate cells; and cause transmission, by the UE, of one or more messages using the one or more activated TCI states associated with the candidate cell. In one embodiment, receiving the indication to deactivate the all TCI states comprises: receiving a bitmap comprising a plurality of bits corresponding to the one or more indicated cells, wherein a bit of the plurality of bits indicates that the UE is to deactivate the all TCI states associated with a respective cell of the one or more indicated cells.

In one embodiment, receiving the indication to deactivate all TCI states comprises: receiving a medium access control control element comprising a bit for activating one or more TCI states or deactivating the all TCI states associated with the one or more indicated cells. In one embodiment, a quantity of octets in the medium access control control element is determined based at least in part on a value of the bit. In one embodiment, the instructions further configure the computer to determine, by the UE, whether to read one or more octets of the medium access control control element based at least in part on a value of the bit. In one embodiment, the bit is further configured to activate one or more TCI states or deactivate the all TCI states, wherein a cell identifier field of the medium access control control element indicates the one or more indicated cells.

In one embodiment, receiving the indication to deactivate the all TCI states comprises: receiving a medium access control control element comprising a logical channel identifier field for deactivating the all TCI states. In one embodiment, receiving the indication to deactivate the all TCI states comprises: receiving a medium access control control element comprising the indication to deactivate the all TCI states and an indication to activate one or more TCI states associated with a candidate cell of the one or more candidate cells. In one embodiment, receiving the indication to deactivate the all TCI states comprises: receiving a medium access control control element comprising (i) a plurality of bits that indicate a plurality of cell identifiers and (ii) a plurality of bits that indicate whether respective previously activated TCI states are activated or deactivated.

In one embodiment, receiving the indication to deactivate the all TCI states comprises: receiving a medium access control control element that activates one or more TCI states associated with a candidate cell of the one or more candidate cells, wherein the UE deactivates all TCI states of one or more candidate cells not indicated by the medium access control control element. In one embodiment, a bit of the medium access control control element indicates that previously activated TCI states are to be deactivated by the UE. In one embodiment, receiving the indication to deactivate the all TCI states comprises: receiving an indication of a beam for a candidate cell of the one or more candidate cells. In one embodiment, the instructions further configure the computer to refrain from performing one or more operations associated with the all TCI states based at least in part on the deactivating. In one embodiment, the all TCI states are associated with cell switching from the serving cell to a candidate cell of the one or more candidate cells.

In one aspect a non-transitory computer-readable storage medium includes instructions that, when executed by a computer, cause the computer to cause transmission, by a network entity and towards a UE, of a configuration of one or more candidate cells for the UE to switch to from a serving cell; and cause transmission, by the network entity and towards the UE, of an indication to deactivate all TCI states associated with one or more indicated cells based at least in part on causing transmission of the configuration of the one or more candidate cells. In one embodiment, one or more of: (i) the one or more candidate cells or (ii) the serving cell comprise the one or more indicated cells.

In one embodiment, the instructions further configure the computer to receive, from the UE, one or more messages using one or more TCI states associated with a candidate cell of the one or more candidate cells. In one embodiment, the instructions further configure the computer to receive, from the UE, one or more messages using one or more TCI states associated with the serving cell. In one embodiment, causing transmission of the indication to deactivate the all TCI states comprises: causing transmission of a bitmap comprising a plurality of bits corresponding to the one or more indicated cells, wherein a bit of the plurality of bits indicates that the UE is to deactivate the all TCI states associated with a respective cell of the one or more indicated cells.

In one embodiment, causing transmission of the indication to deactivate all TCI states comprises: causing transmission of a medium access control control element comprising a bit for activating one or more TCI states or deactivating the all TCI states associated with the one or more indicated cells. In one embodiment, a quantity of octets in the medium access control control element is determined based at least in part on a value of the bit. In one embodiment, the bit is further configured to activate one or more TCI states or deactivate the all TCI states, wherein a cell identifier field of the medium access control control element indicates the one or more indicated cells.

In one embodiment, causing transmission of the indication to deactivate the all TCI states comprises: causing transmission of a medium access control control element comprising a logical channel identifier field for deactivating the all TCI states. In one embodiment, causing transmission of the indication to deactivate the all TCI states comprises: causing transmission of a medium access control control element comprising the indication to deactivate the all TCI states and an indication to activate one or more TCI states associated with a candidate cell of the one or more candidate cells. In one embodiment, causing transmission of the indication to deactivate the all TCI states comprises: causing transmission of a medium access control control element comprising (i) a plurality of bits that indicate a plurality of cell identifiers and (ii) a plurality of bits that indicate whether respective previously activated TCI states are activated or deactivated.

In one embodiment, causing transmission of the indication to deactivate the all TCI states comprises: causing transmission of a medium access control control element that activates one or more TCI states associated with a candidate cell of the one or more candidate cells, wherein the UE deactivates all TCI states of one or more candidate cells not indicated by the medium access control control element. In one embodiment, a bit of the medium access control control element indicates that previously activated TCI states are to be deactivated by the UE. In one embodiment, causing transmission of the indication to deactivate the all TCI states comprises: causing transmission of an indication of a beam for a candidate cell of the one or more candidate cells. In one embodiment, the all TCI states are associated with cell switching from the serving cell to a candidate cell of the one or more candidate cells. Although some examples described herein may refer to specific combinations of operations being performed together, any combination of the operations described herein may be performed. For example, an example embodiment may include any combination of the operations described herein.

### BRIEF DESCRIPTION OF THE DRAWINGS

Having thus described certain example embodiments of the present disclosure in general terms, reference will be made herein to the accompanying drawings, which are not necessarily drawn to scale, and wherein:

FIG. 1 illustrates a signal flow diagram that provides examples of signaling associated with activation and deactivation of transmission configuration indicator (TCI) states;

FIG. 2 illustrates a message format that supports techniques for TCI state activation and deactivation in accordance with examples described herein;

FIG. 3 illustrates an example of a wireless communications system that supports techniques for TCI state activation and deactivation in accordance with examples described herein;

FIG. 4 is an example of an apparatus that supports techniques for TCI state activation and deactivation in accordance with examples described herein;

FIGS. 5-8 illustrate examples of message formats that support techniques for TCI state activation and deactivation in accordance with examples described herein; and

FIGS. 9-10 are flowcharts of operations according to certain example embodiments implemented, for example, by an apparatus as described herein.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with certain embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

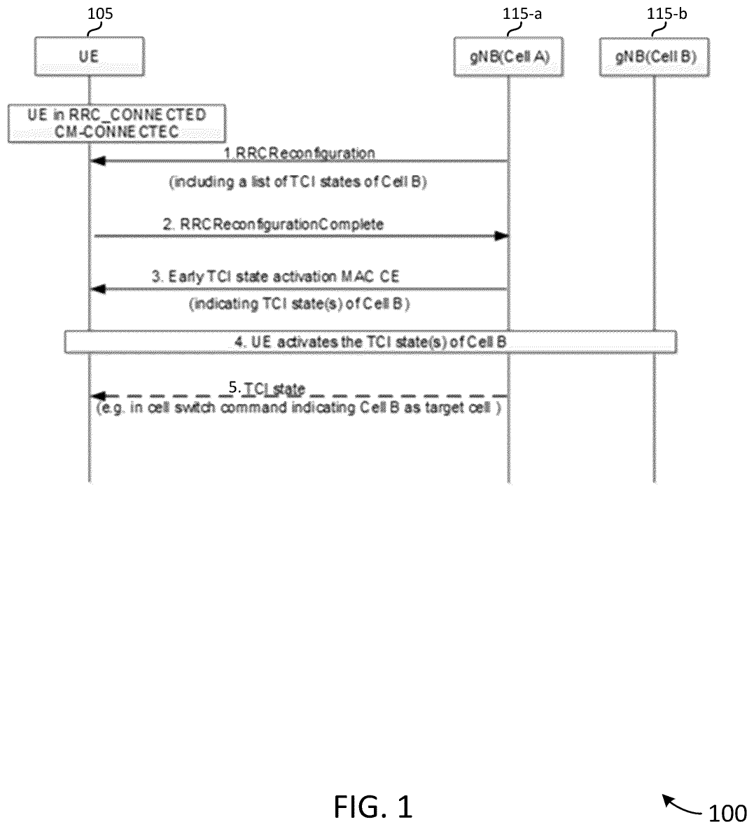

FIG. 1 illustrates an example of a signal flow diagram 100 that supports transmission configuration indicator (TCI) state deactivation and activation in accordance with examples described herein. The signal flow diagram 100 may include a user equipment (UE) 105, a cell 115-a (e.g., cell A), and a cell 115-b (e.g., cell B). Each cell 115 may be associated with a next generation node B (gNB) (e.g., a base station, a network entity). In some cases, the cell 115-a and the cell 115-b may be cells 115 of a same gNB. In some other cases, each cell 115 may correspond to a different gNB. Some examples described herein that refer to various cells 115 may also implicitly refer to a corresponding gNB. For example, a UE 105 that communicates with a cell 115 may be understood to communicate with a gNB that corresponds to the cell 115 (e.g., a gNB to which the cell 115 belongs).

The signal flow diagram 100 may provide one illustrative example of an order or sequencing for the operations described herein, however, any order or sequencing may be used. In some cases, one or more operations of the signal flow diagram 100 may not be performed or may otherwise be omitted. Additionally, or alternatively, the UE 105 and the cells 115 (e.g., gNBs corresponding to the cells 115) may perform operations that are not shown in the signal flow diagram 100. For example, the UE 105 may receive an indication from a gNB (e.g., a network entity) to deactivate one or more (e.g., all) TCI states for one or more cells (e.g., one or more cells indicated by the gNB). Although not shown in FIG. 1, the indication may be received between, before, or after any of the operations shown. Additionally, or alternatively, any of the operations shown (e.g., any of the communications shown) may include the indication. It should also be understood that any of the operations described herein may be performed independently of other operations described herein. For example, the UE 105 may receive the signaling described at step 3 and may not receiving the signaling described at step 5, among other examples.

In some cases, the UE 105 may switch between cells 115. For example, the UE 105 may switch (e.g., be handed over) from the cell 115-a to the cell 115-b. In some cases, the UE 105 may switch from the cell 115-a to the cell 115-b based on a determination (e.g., by the UE 105, by a network entity) that the UE 105 has left or is about to leave a coverage area for the cell 115-a and enter a coverage area for the cell 115-b. In some cases, the UE 105 may switch from the cell 115-a to the cell 115-b based on a determination (e.g., by the UE 105, by a network entity) that a quality of service (QOS) or a reference signal received power (RSRP) for the cell 115-a fails to satisfy a threshold (e.g., is below a threshold). In some cases, operations and signaling associated with switching between cells 115 may be performed in accordance with a lower-layer triggered mobility (LTM) framework. For example, the LTM framework may enable the UE 105 to switch from the cell 115-a to the cell 115-b based on one or more determinations made at or with respect to lower layers of the network protocol stack.

The UE 105 may communicate (e.g., with cells 115) using one or more TCI states. A TCI state may be a configuration or may otherwise indicate one or more communication configurations. For example, a TCI state (or one or more reference signals included in or otherwise associated with the TCI State) may correspond to or otherwise indicate a quasi-colocation (QCL) relationship for communications. A TCI state may be associated with a cell 115. For example, the UE 105 may communicate via the cell 115 using one or more TCI states (e.g., using one or more parameters/reference signals indicated by or otherwise corresponding to the TCI state). In some cases, a TCI state may be for uplink communications, downlink communications, or both. A TCI state for uplink and downlink communications may be referred to as a joint TCI state. A TCI state for either uplink or downlink communications may be referred to as a separate TCI state.

In some cases, the UE 105 may receive an indication of one or more TCI states from a gNB and activate the one or more TCI states based on receiving the indication. In some cases, the TCI states may be configured and otherwise communicated in accordance with one or more protocols or frameworks, such as a unified TCI state framework. According to the unified TCI state framework, TCI states may be communicated using one or more medium access control control elements (MAC CEs). In some cases, the unified TCI state framework may be utilized for LTM scenarios. The following operations may include one or more examples of TCI states being communicated and activated during a cell switch procedure.

Prior to step 1, the UE 105 may be in a radio resource control (RRC) connected state. For example, the UE 105 may have previously established one or more communication links with a gNB (e.g., with a cell 115 of a gNB). The RRC connected state may enable the UE 105 to perform communications with the gNB. Additionally, or alternatively, the UE 105 may perform one or more operations, such as monitoring for communications, based on being in the RRC connected state. In some cases, the UE 105 may be connected to a gNB to which the cell 115-a belongs (e.g., is associated with, corresponds to). In some other cases, the UE 105 may be connected to one or more other gNBs (not shown).

At step 1, the UE 105 may receive signaling (e.g., a message) from a gNB to which the cell 115-a belongs. The signaling may be RRC signaling (e.g., an RRC reconfiguration message, a configuration of one or more candidate cells for switching to). In some cases, the signaling may include a list of TCI states for one or more other cells 115 (e.g., the cell 115-b). In some cases, the list of TCI States may refer to an LTM specific list of TCI States. In some cases, the signaling may include or otherwise indicate a timing advance (TA) acquisition configuration to the UE 105. The TA acquisition configuration may include all RRC configuration information for the UE 105 to send a random access (RA) preamble to a gNB to which the cell 115-b belongs. In such cases (e.g., when the UE 105 sends the RA preamble), the gNB to which the cell 115-b belongs may calculate a TA value used by the UE 105 (e.g., in case an LTM cell switch procedure is performed and the UE 105 switches to the cell 115-b). The TA acquisition configuration may include information for one or more cells 115. The one or more cells 115 may be candidate cells 115 for the UE 105 (e.g., cells 115 that the UE 105 performs the TA acquisition procedure for).

At step 2, the UE 105 may transmit a message to the gNB to which the cell 115-a belongs in response to receiving the signaling from the gNB at step 1. The message transmitted by the UE 105 at step 2 may indicate that an RRC reconfiguration operation is complete (e.g., an RRCReconfigurationComplete message). The UE 105 may transmit the message based on determining that the list of TCI states was successfully received from the gNB to which the cell 115-a belongs. Additionally, or alternatively, the UE 105 may transmit the message based on determining that the TA acquisition configuration has been successfully received.

At step 3, the UE 105 may receive an indication (e.g., a command) to activate one or more TCI states. The indication may be transmitted by a gNB to which to the cell 115-a belongs. The indication may be received in a MAC CE and may instruct the UE 105 to activate one or more TCI states (e.g., any combination of one or more joint TCI states and one or more separate TCI states). The one or more indicated TCI states may be for one or more candidate cells 115 (e.g., for the cell 115-b, among other examples). Additionally, or alternatively, the gNB to which cell 115-a belongs may transmit, to the UE 105, a physical downlink control channel (PDCCH) order message to initiate a TA acquisition procedure with the cell 115-b. The PDCCH order message may include information for sending a RA preamble to a gNB to which to cell 115-b belongs.

At step 4, the UE 105 may transmit (e.g., cause transmission of) the RA preamble to the gNB to which the cell 115-b belongs. The UE 105 may transmit the RA preamble so that the gNB to which the cell 115-b belongs may estimate a TA value to be used by the UE 105 (e.g., if an LTM cell switch procedure is triggered to switch the UE 105 to the cell 115-b). In some cases, the gNB to which the cell 115-a belongs may indicate a retransmission of the RA preamble for the TA acquisition if no TA is obtained (e.g., by the gNB to which the cell 115-a belongs). Additionally, or alternatively, the UE 105 may activate one or more TCI states for the cell 115-b. The UE 105 may activate the one or more TCI states for the cell 115-b in response to receiving the indication to activate the one or more TCI states from the gNB to which the cell 115-a belongs.

At step 5, the UE 105 may receive a cell switch command from the gNB to which the cell 115-a belongs. The cell switch command may instruct the UE 105 to switch from the cell 115-a to the cell 115-b. In some cases (e.g., if not performed prior to the cell switch command being received), the cell switch command may indicate or otherwise activate one or more TCI states for the target cell (e.g., the cell 115-b). Additionally, or alternatively, early TCI state activation may be performed prior to step 5. In some cases, the gNB to which the cell 115-a belongs may provide the TA value calculated by the gNB to which the cell 115-b belongs during the TA acquisition procedure (e.g., in an LTM cell switch command MAC CE, which initiates the cell switch to the cell 115-b). As shown in FIG. 1, the dashed line shown at step 5 may indicate that the corresponding signaling or a portion of the corresponding signaling is optional.

Upon activation of one or more TCI states, the UE 105 may perform one or more operations associated with the one or more TCI states. For example, the UE 105 may communicate and measure one or more reference signals for each activated TCI state. Additionally, or alternatively, the UE 105 may perform one or more operations to track (e.g., monitor, store, update) timing information for each activated TCI state. In such cases, time tracking or time and frequency tracking operations performed by the UE 105 may be based on a downlink reference signal corresponding to a TCI state. As described herein, performing the one or more operations associated with the one or more active TCI states may be referred to as tracking or monitoring one or more TCI states.

In some cases, a UE 105 may unnecessarily monitor one or more TCI states (e.g., one or more activated TCI states), which may consume excess resources at the UE 105. For example, the UE 105 may receive a MAC CE activating multiple TCI states for a potential cell switch procedure. However, the cell switch procedure may not occur (e.g., if the UE 105 reverses direction, or if communication quality on a serving cell improves, among other examples), and the UE 105 may continue to monitor the one or more TCI states. In some other cases, TCI states for multiple candidate cells (e.g., cells 115 in consideration for a potential cell switch) may be activated at the UE 105, and the UE 105 may subsequently switch to a single candidate cell of the multiple candidate cells. In such cases, the UE 105 may continue to monitor TCI states for all of the candidate cells even if the UE 105 only utilizes one or more TCI states for the single candidate cell. In such cases, monitoring TCI states that are not utilized may consume power and resources at the UE 105, which may be undesirable.

In accordance with one or more examples as described herein, a UE 105 may deactivate or otherwise refrain from monitoring one or more TCI states based on receiving an indication from a gNB (e.g., a network entity) to deactivate the one or more TCI states, which may conserve resources of the UE 105. The indication to deactivate the one or more TCI states may be based on a determination (e.g., by the UE 105, by the network entity) that the UE 105 is not utilizing or is not expected to utilize the one or more TCI states. In some cases, the indication may indicate to deactivate all of the TCI states for one or more cells 115. In some examples, the TCI states being deactivated may be TCI States specific for LTM cell switching/beam indication. In some cases, the indication may be transmitted to the UE 105 by the gNB to which the cell 115-a belongs, the gNB to which the cell 115-b belongs, or both. The indication may be communicated using a variety of formats (e.g., a variety of types of messages, a variety of message formats) as described in further detail herein. Additionally, or alternatively, any of the communications described in the signal flow diagram 100 may include the indication. Although some examples described herein refer to deactivation of one or more TCI states, the indication may also indicate that one or more TCI states should be activated.

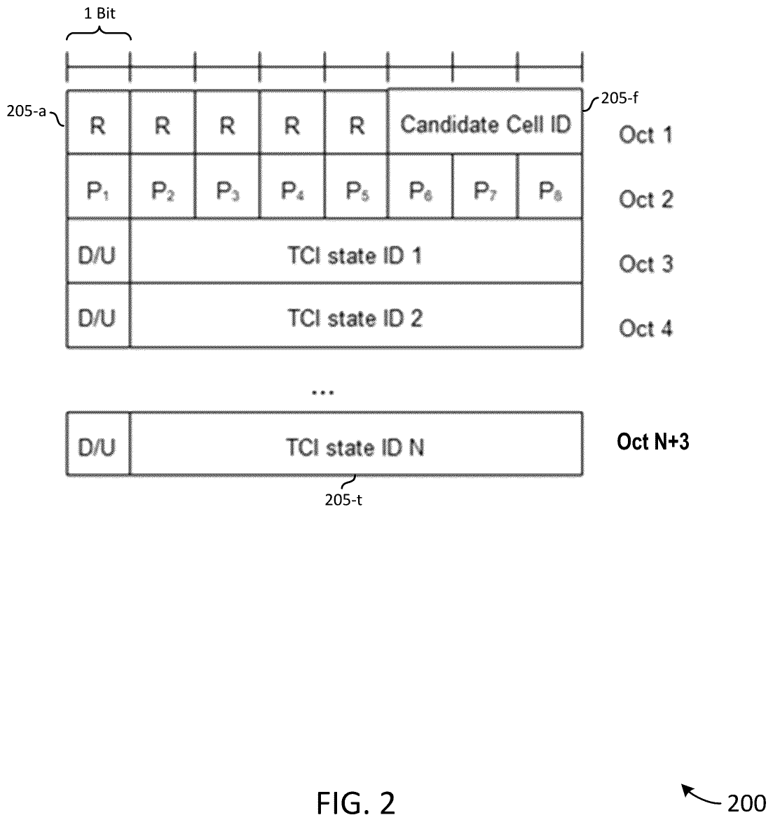

FIG. 2 illustrates an example of a message format 200 that supports TCI state deactivation and activation in accordance with examples described herein. The message format 200 may be an example of a MAC CE (e.g., a MAC CE format), which may include one or more elements 205. For example, the element 205-a, the element 205-b, the element 205-c, the element 205-d, and the element 205-e may each correspond to or otherwise be examples of reserved bits (e.g., empty bits, bits that may not be currently utilized). The element 205-f may indicate or otherwise correspond to a candidate cell ID. The element 205-g, the element 205-h, the element 205-i, the element 205-j, the element 205-k, the element 205-l, the element 205-m, and the element 205-n may each indicate or otherwise correspond to TCI state quantity fields (e.g., P₁ through P₈, which may indicate whether each TCI codepoint has multiple TCI states or a single TCI state). The element 205-o, the element 205-q, and the element 205-s may each indicate or otherwise correspond to communication direction fields (e.g., indicating downlink, uplink, or both for a TCI state ID in a respective octet). The element 205-p, the element 205-r, and the element 205-t may each indicate or otherwise correspond to TCI state identifiers (IDs). Each element 205 may correspond to an octet (e.g., octet 1 through octet N+3), which may include respective rows of elements 205. Each element 205 may include or otherwise correspond to a quantity of bits. For example, the element 205-a may include one bit and the element 205-f may include three bits.

The message format 200 (e.g., the MAC CE) may be an illustrative example of a MAC CE utilized for activating or deactivating one or more TCI states. The message format 200 may be communicated (e.g., by a network entity, by a UE 105) to activate, request activation of, or indicate activation of one or more TCI states for one or more cells (e.g., one or more candidate cells). As described herein, the term “candidate cell” may refer to a cell (e.g., a cell 115) that a UE 105 may switch to (e.g., during an LTM cell switch). In some cases, a UE 105 may be provided with a quantity of (e.g., a set of, a plurality of) candidate cells and may switch to one or more of the candidate cells.

As shown, the message format 200 may include one or more reserved bits (e.g., elements 205-a through 205-e), one or more candidate cell ID fields (e.g., the element 205-f), one or more TCI state quantity fields (e.g., elements 205-g through 205-n), one or more communication direction fields (e.g., the element 205-o, the element 205-q, the element 205-s), one or more TCI state ID fields (e.g., the element 205-p, the element 205-r, and the element 205-t), and one or more other fields (not shown), which may be utilized to indicate information for deactivating or activating one or more TCI states. The message format 200 may be identified by or otherwise include a subheader (e.g., a MAC subheader) (not shown). The subheader may include one or more elements 205 (e.g., one or more bits) that indicate information associated with the message format 200. For example, the subheader may include one or more logical channel identifier (LCID) fields and one or more extended logical channel identifier ((e) LCID) fields, among other examples. Additionally, the message format 200 may be configurable (e.g., may have a variable size, may have a variable quantity of bits).

The candidate cell ID field may indicate one or more IDs for one or more cells that the message format 200 applies to (e.g., that the information in the message format 200 applies to). In some cases, the candidate cell ID field may indicate one or more LTM candidate cells for a UE 105. The TCI state quantity fields (e.g., P₁ through P₈) may indicate whether each TCI codepoint (e.g., corresponding to each TCI state ID) has multiple TCI states or a single TCI state. If a TCI state quantity field is set to “1,” a respective TCI codepoint may include the joint/downlink TCI state and the uplink TCI state. If the TCI state quantity field is set to “0,” the respective TCI codepoint may include only a joint/downlink TCI state or an uplink TCI state. The codepoint to which a TCI state is mapped may be determined by its ordinal position among all the TCI state ID fields. For example, the field P₁ may be mapped to the TCI state ID field 1, the field P₂ may be mapped to the TCI state ID field 2, and so forth.

The communication direction fields (e.g., D/U fields) may indicate whether a respective TCI state ID field (e.g., a TCI state ID field in the same octet) is for a joint/downlink TCI state or an uplink TCI state. For example, if a communication direction field is set to “1,” the TCI state ID in the same octet is for joint or downlink communications. If the communication direction field is set to “0,” the TCI state ID in the same octet is for uplink communications. The TCI state ID fields indicate TCI states. The TCI states may be identified by TCI-StateId or TCI-UL-StateId. A corresponding communication direction field may identify or otherwise control which variable (e.g., TCI-StateId or TCI-UL-StateId) is used. For example, if a communication direction field (e.g., a D/U field in the same octet) is set to “1,” a 7-bit length TCI state ID (e.g., TCI-StateId) is used. If D/U is set to “0,” a most significant bit of TCI state ID is used as a reserved bit (e.g., not used, reserved) and the remaining 6 bits may indicate the TCI state (e.g., using TCI-UL-StateId). A maximum number (e.g., a maximum quantity) of activated TCI states may be 16 TCI states.

In accordance with one or more examples as described herein, a UE 105 may deactivate or otherwise refrain from monitoring one or more TCI states based on receiving an indication from a gNB (e.g., a network entity) to deactivate the one or more TCI states, which may conserve resources of the UE 105. The indication may be communicated by the gNB via the message format 200. For example, the message format 200 may include one or more bits that indicate one or more TCI states to be deactivated by the UE 105. For example, a reserved bit (e.g., an element 205-a) of the message format 200 may indicate that one or more TCI states should be deactivated. Although one example of a TCI state deactivation indication includes using a reserved bit to indicate that one or more TCI states should be deactivated, other types of indications and other message formats may be utilized (e.g., individually or in combination), which are described in further detail herein.

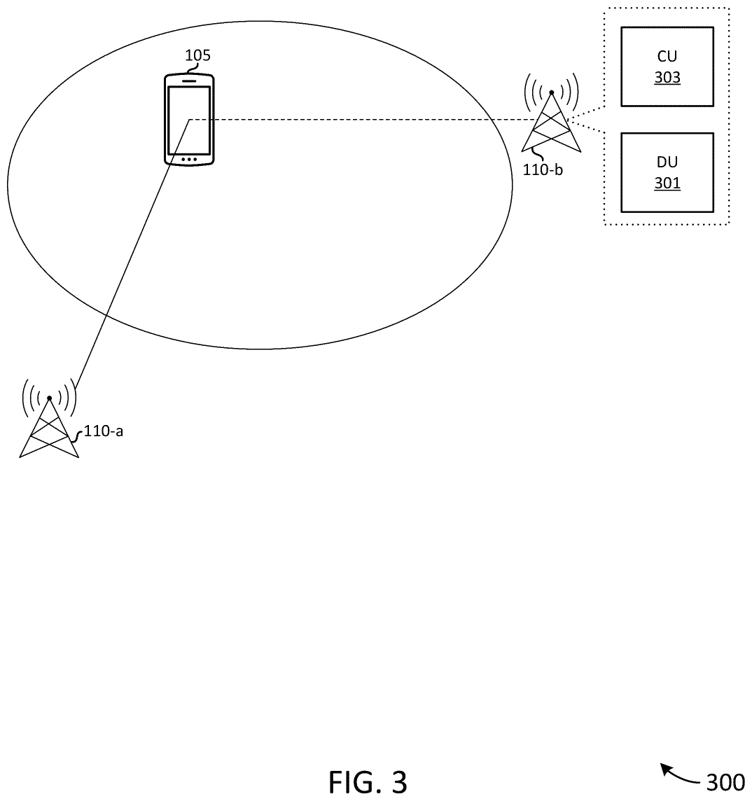

FIG. 3 illustrates an example of a wireless communications system 300 that supports TCI state deactivation and activation in accordance with examples described herein. In some embodiments, the wireless communications system 300 may include one or more UEs 105 and one or more gNBs 110 (e.g., base stations) of a RAN (e.g., of the RAN 120) which may be in communication with each other. Although some examples described herein may refer to operations performed by a gNB 110, such operations may additionally or alternatively be performed by any network entity, such as an access point or a node (e.g., a Node B, a gNB), or the like of a RAN. In some cases, the UEs 105 and/or the RAN, such as the gNBs 110 of the RAN, may be in communication with a core network including one or more network nodes of the core network. As shown, gNBs 110 of an example embodiment may include one or more centralized units (CUs) 303 and one or more distributed units (DUs) 301. Additionally, each gNB 110 may provide coverage for or otherwise support one or more cells (e.g., one or more coverage areas).

By way of example, the wireless communications system 300 may be deployed within a radio access architecture based on long term evolution advanced (LTE Advanced, LTE-A) and/or new radio (NR, 5G). However, the system may be deployed in other network architectures including within other communication networks including, for example, other communication networks developed in the future, e.g., sixth generation (6G) networks, as well as any of a number of existing networks including a universal mobile telecommunication system (UMTS), radio access network (UTRAN or E-UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The UE 105 may be any type of user terminal, terminal device, node (e.g., network node), element (e.g., network element), etc. to which resources on the air interface are allocated and assigned. For example, the UE 105 may be a portable computing device such as a wireless mobile communication device including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, car, truck, drone, airplane and other types of vehicles. As a non-exhaustive list of some examples, the UE 105 may also be called a subscriber unit, mobile station, network element, remote terminal, access terminal, or user terminal.

In some cases, a UE 105 and gNB 110 may perform one or more beam management operations, which may include activation of various TCI states. For intra-cell (serving cell) or inter-cell beam management, once a TCI state (e.g., a unified TCI state) has been activated, deactivation of previously activated TCI states may not be performed. For serving cell beam management within a unified TCI State framework, deactivation of TCI states may not occur. For LTM, a UE 105 may receive one or more activation commands to activate one or more TCI states for one or more LTM candidate cells. In some cases, the one or more activation commands may be received via a MAC CE prior to a cell switch command for one or more candidate cells. In some cases, other types of signaling may be used to activate TCI states. In some cases, a UE 105 may continue to monitor TCI states that are activated (e.g., until the UE 105 is reconfigured or until a cell switch occurs). This may cause the UE 105 to monitor TCI states that are no longer relevant for cell switch purposes (e.g., the network may prefer another cell for a cell switch or determine that the UE 105 will not switch cells). Accordingly, in LTM, no existing techniques may enable a UE 105 to deactivate TCI states (e.g., deactivate all the TCI states for the one or more candidate cells).

In accordance with one or more examples as described herein, a UE 105 may receive one or more indications from a gNB 110 (e.g., a network entity) to deactivate one or more (e.g., all) TCI states for one or more indicated cells (e.g., of the gNB 110-a, of the gNB 110-b), which may improve resource utilization at the UE 105. The one or more indicated cells may include one or more candidate cells, one or more serving cells (e.g., one or more cells that previously served the UE 105), or any combination thereof. The UE 105 may then deactivate the one or more TCI states (e.g., all TCI states) for the one or more indicated cells based on receiving the one or more indications to deactivate the one or more TCI states. The one or more indications may be communicated using one or more types of signaling (e.g., using a message format of a plurality of message formats), which are described herein in further detail. The type of signaling for the one or more indications may be selected by the UE 105 or the gNB 110. In some other cases, the type of signaling may be preconfigured. As described herein, the indication of TCI states for deactivation may enable a UE 105 to conserve communication resources and to reduce power consumption. The techniques described herein may also provide more efficient signaling when compared to other techniques. In some cases, the techniques described herein may provide scheduling flexibility for the network, which may enable increased throughput.

In some cases, the UE 105 may receive a configuration of one or more candidate cells (e.g., for a cell switch operation). The configuration may be received prior to receiving the indication to deactivate the one or more TCI states. In some cases, the configuration may be received concurrently with the indication to deactivate the one or more TCI states. The configuration may be transmitted to the UE 105 using any type of signaling, such as a MAC CE or RRC signaling. The configuration may indicate one or more candidate cells for the UE 105. In some cases, the UE 105 may perform the cell switch. For example, the UE 105 may switch from a serving cell to a candidate cell of the one or more candidate cells. In such cases, receiving the indication to deactivate the TCI states may be based on the UE 105 performing the cell switch. In some other cases, the UE 105 may not perform the cell switch and receiving the indication to deactivate the TCI states may be based on the UE 105 not performing the cell switch. Additionally, or alternatively, receiving the indication to deactivate the TCI states may be based on receiving the configuration of the one or more candidate cells and/or receiving a configuration of one or more TCI states (e.g., LTM TCI states) associated with the one or more candidate cells.

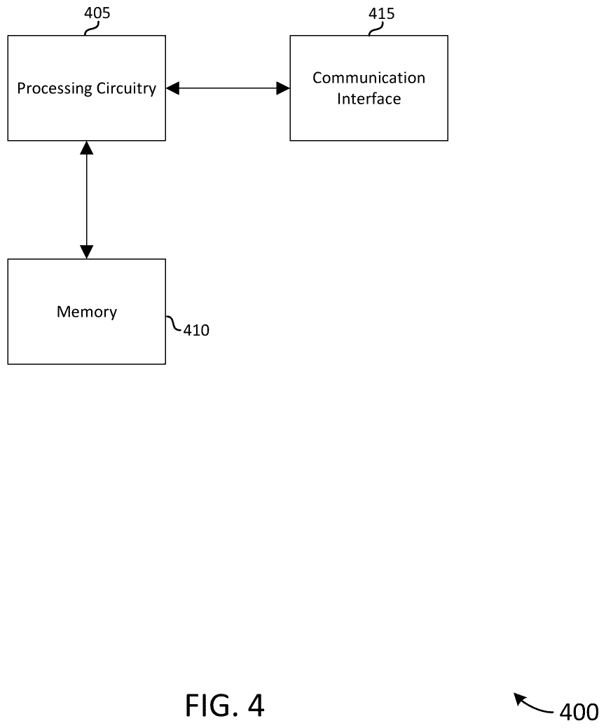

FIG. 4 illustrates an example of an apparatus 400 that supports TCI state deactivation and activation in accordance with examples described herein. The apparatus 400 may be embodied by or may comprise a UE 105 or a gNB 110, configured to perform communications that deactivate or request deactivation of TCI states. As shown in FIG. 4, the apparatus 400 may include, be associated with, or be in communication with processing circuitry 405 (e.g., one or more processors), a memory 410 and a communication interface 415. The processing circuitry 405 may be in communication with the memory 410 via a bus for passing information among components of the apparatus 400. The memory 410 may be non-transitory and may include, for example, one or more volatile and/or non-volatile memories. In other words, for example, the memory 410 may be an electronic storage device (e.g., a computer readable storage medium) comprising storage components configured to store data (e.g., bits) that may be retrievable by a machine (e.g., a computing device like the processing circuitry 405). The memory 410 may be configured to store information, data, content, applications, instructions, or the like for enabling the apparatus 400 to carry out various functions in accordance with an example embodiment of the present disclosure. Additionally, or alternatively the memory 410 may be configured to store instructions for execution by the processing circuitry 405.

The apparatus 400 may, in some embodiments, be embodied in various computing devices as described above. However, in some embodiments, the apparatus 400 may be embodied as a chip or chip set. In other words, the apparatus 400 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 400 may therefore, in some cases, be configured to implement an embodiment of the present invention on a single chip or as a single “system on a chip.” As such, in some cases, a chip or chipset may constitute means for performing one or more operations for providing the functionalities described herein.

The processing circuitry 405 may be embodied in a number of different ways. For example, the processing circuitry 405 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 405 may include one or more processing cores configured to perform independently. A multi-core processing circuitry may enable multiprocessing within a single physical package. Additionally, or alternatively the processing circuitry 405 may include one or more processors configured in tandem via the bus to enable independent execution of instructions, pipelining and/or multithreading.

In an example embodiment, the processing circuitry 405 may be configured to execute instructions stored in the memory 410 or otherwise accessible to the processing circuitry 405. Additionally, or alternatively, the processing circuitry 405 may be configured to execute hard coded instructions. As such, whether configured by hardware or software methods, or by a combination thereof, the processing circuitry 405 may represent an entity (e.g., physically embodied in circuitry) capable of performing operations according to an embodiment of the present disclosure while configured accordingly. Thus, for example, when the processing circuitry 405 is embodied as an ASIC, FPGA or the like, the processing circuitry 405 may be specifically configured hardware for conducting the operations described herein. Alternatively, as another example, when the processing circuitry 405 is embodied as an executor of instructions, the instructions may specifically configure the processing circuitry 405 to perform the algorithms and/or operations described herein when the instructions are executed. However, in some cases, the processing circuitry 405 may be a processor of a specific device (e.g., an image or video processing system) configured to employ an embodiment of the present invention by further configuration of the processing circuitry 405 by instructions for performing the algorithms and/or operations described herein. The processing circuitry 405 may include, among other things, a clock, an arithmetic logic unit (ALU) and logic gates configured to support operation of the processing circuitry 405.

The communication interface 415 may be any means such as a device or circuitry embodied in either hardware or a combination of hardware and software that is configured to receive and/or transmit data, including media content in the form of video or image files, one or more audio tracks or the like. In this regard, the communication interface 415 may include, for example, an antenna (or multiple antennas) and supporting hardware and/or software for enabling communications with a wireless communication network. Additionally, or alternatively the communication interface 415 may include one or more antennas to cause transmission of signals via the one or more antennas or to handle receipt of signals received via the one or more antennas. In some environments, the communication interface 415 may alternatively or also support wired communication. As such, for example, the communication interface 415 may include a communication modem and/or other hardware/software for supporting communication via cable, digital subscriber line (DSL), universal serial bus (USB) or other mechanisms.

In some cases, the apparatus 400 may perform one or more operations to improve resource utilization of another apparatus 400. For example, the apparatus 400 (e.g., a UE 105), in accordance with one or more examples as described herein, may receive one or more indications from another apparatus 400 (e.g., a gNB 110) to deactivate one or more (e.g., all) TCI states for one or more indicated cells (e.g., of the gNB 110-a, of the gNB 110-b), which may improve resource utilization of the apparatus 400. The one or more indicated cells may include one or more candidate cells, one or more serving cells (e.g., one or more cells that previously served the UE 105), or any combination thereof. The apparatus 400 may then deactivate the one or more TCI states (e.g., all TCI states) for the one or more indicated cells based on receiving the one or more indications to deactivate the one or more TCI states. The one or more indications may be communicated using one or more types of signaling (e.g., using a message format of a plurality of message formats), which are described herein in further detail. The type of signaling for the one or more indications may be selected by the apparatus 400. In some other cases, the type of signaling may be preconfigured.

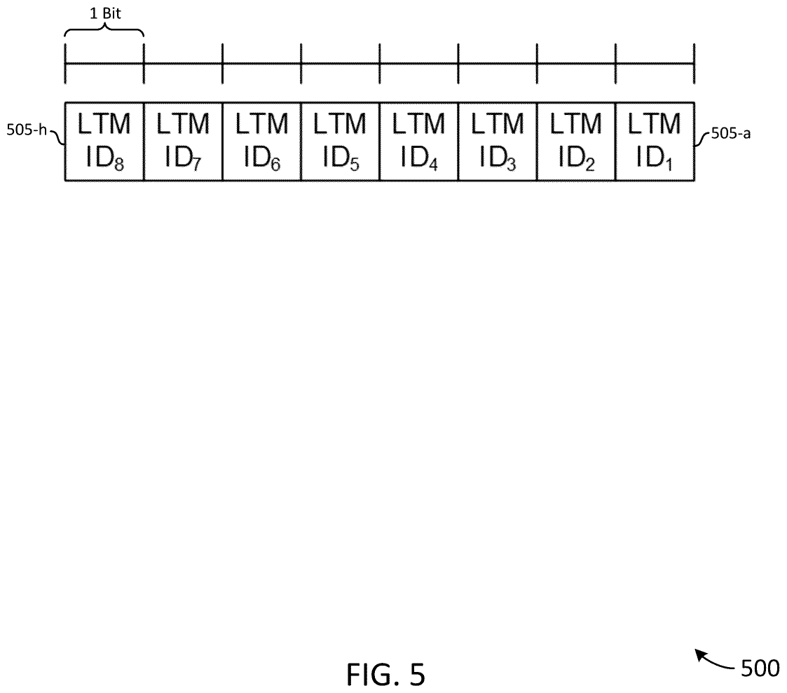

FIG. 5 illustrates an example of a message format 500 that supports TCI state deactivation and activation in accordance with examples described herein. The message format 500 may be an example of a bitmap, which may be communicated via a MAC CE (e.g., in the message format 200), or any other type of signaling (e.g., any other type of message). The bitmap may include one or more elements 505. For example, the bitmap may include an element 505-a (e.g., LTM ID₁), an element 505-b (e.g., LTM ID₂), an element 505-c (e.g., LTM ID₃), an element 505-d (e.g., LTM ID₄), an element 505-e (e.g., LTM ID₅), an element 505-f (e.g., LTM ID₆), an element 505-g (e.g., LTM ID₇), and an element 505-h (e.g., LTM ID₈). Each element 505 may include or otherwise correspond to a quantity of bits. For example, the element 505-a may include one bit. In some cases, each element 505 of the bitmap may include one bit. As described herein, each element 505 may correspond to or otherwise indicate an LTM candidate cell ID (e.g., an LTM candidate cell configuration ID). In some examples, the bitmap may include a bit position associated with the configured one or more candidate cells in the ascending order of the candidate cell configuration identifier. As an example, the first bit position of the bitmap (e.g., LTM ID₁) may be associated with the lowest candidate cell configuration identifier. The second bit position (LTM ID₂) may be associated with the second lowest candidate cell configuration identifier and so on. In another example, if a UE is configured with candidate cell identifiers 0, 1, 3, (e.g., where the ID space may range from 0 to 7) the candidate cell identifiers may map to the LTM ID bit positions (e.g., 1, 2, 3). In an alternative example, the bit positions may be associated with the candidate cell configuration identifiers in their candidate ID specific bit positions. As an example, if a UE is configured with candidate cell identifiers 0, 1, 3, the candidate cell identifiers may map to LTM ID bit positions (e.g., 1, 2, 4).

The message format 500 (e.g., the bitmap) may be an illustrative example of a bitmap (e.g., a portion of a MAC CE) utilized for deactivating one or more TCI states. The message format 500 may be communicated (e.g., by a network entity, by a UE 105) to deactivate, request deactivation of, or indicate deactivation of one or more TCI states (e.g., all TCI states) for one or more cells (e.g., one or more candidate cells). For example, a UE 105 may deactivate or otherwise refrain from monitoring one or more TCI states based on receiving an indication from a gNB 110 (e.g., a network entity) to deactivate the one or more TCI states, which may conserve resources of the UE 105. The indication may be communicated by the gNB via the message format 500.

If a bit (e.g., corresponding to a respective element 505) of the message format 500 is set to a value of “1,” or another value indicating the deactivation, a UE 105 may deactivate all of the TCI states corresponding to a respective one or more cells (e.g., one or more LTM candidate cells) indicated by the respective bit. For example, if a bit corresponding to the element 505-a is set to a value of “1,” (e.g., a first logic state), a UE 105 may deactivate all of the TCI states for the cell associated with the bit position of LTM ID₁. If a bit of the message format 500 is set to a value of “0,” (e.g., a second logic state), a UE 105 may refrain from deactivating one or more TCI states (e.g., all of the TCI states) corresponding to a respective one or more cells. For example, if the bit is set to a value of “0,” the UE 105 may refrain from deactivating TCI states corresponding to the respective one or more cells associated with the bit (e.g., the bit position) if the TCI states are already active. In some cases, candidate cell IDs may be mapped to bit positions in the message format 500 in ascending order from right to left. For example, a lowest configured candidate cell ID may be mapped to the element 505-a (e.g., a first bit position in the message format 500). The lowest configured candidate cell ID may be a candidate cell ID that is configured chronologically first when compared to other candidate cell IDs, or a candidate cell ID that has a lowest ID value (e.g., the ID range may vary from 0 to 7 if three bits are used). In some cases, the message format 500 may include an LCID (not shown) that identifies the message format 500. For example, the LCID may indicate that the message format 500 is being used (e.g., as an alternative to other message formats).

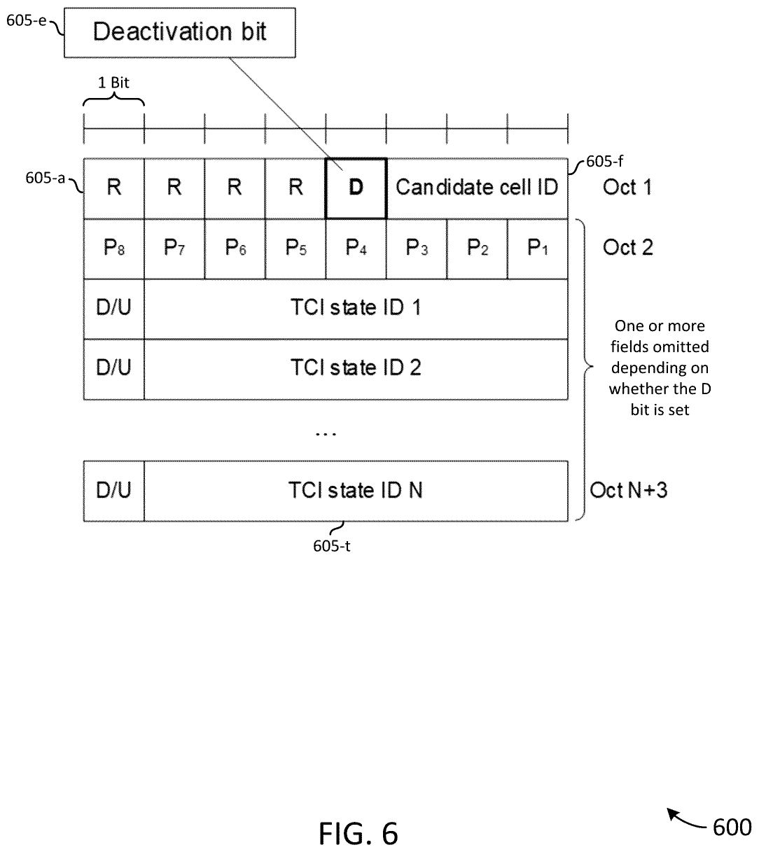

FIG. 6 illustrates an example of a message format 600 that supports TCI state deactivation and activation in accordance with examples described herein. The message format 600 may be an example of a MAC CE (e.g., a MAC CE format), which may include one or more elements 605. For example, the element 605-a, the element 605-b, the element 605-c, and the element 605-d, may each correspond to or otherwise be examples of reserved bits (e.g., empty bits, bits that may not be currently utilized). The element 605-e may correspond to or otherwise be an example of a deactivation bit. The element 605-f may indicate or otherwise correspond to a candidate cell ID. The element 605-g, the element 605-h, the element 605-i, the element 605-j, the element 605-k, the element 605-l, the element 605-m, and the element 605-n may each indicate or otherwise correspond to TCI state quantity fields (e.g., P₁ through P₈). The element 605-o, the element 605-q, and the element 605-s may each indicate or otherwise correspond to communication direction fields (e.g., indicating downlink, uplink, or both for a TCI state ID in a respective octet). The element 605-p, the element 605-r, and the element 605-t may each indicate or otherwise correspond to TCI state identifiers IDs. Each element 605 may correspond to an octet (e.g., octet 1 through octet N+3), which may include respective rows of elements 605. Each element 605 may include or otherwise correspond to a quantity of bits. For example, the element 605-a may include one bit and the element 605-f may include three bits.

The message format 600 (e.g., the MAC CE) may be an illustrative example of a MAC CE utilized for activating or deactivating one or more TCI states. The message format 600 may be communicated (e.g., by a network entity, by a UE 105) to activate, request activation of, or indicate activation of one or more TCI states for one or more cells (e.g., one or more candidate cells). As shown, the message format 600 may include one or more deactivation bits (e.g., one or more elements 605-c), which may be utilized to indicate information for deactivating one or more TCI states. The message format 600 may be identified by a subheader (e.g., a MAC subheader) (not shown). The subheader may include one or more elements 605 (e.g., one or more bits) that indicate information associated with the message format 600. For example, the subheader may include one or more LCID fields and one or more (e) LCID fields, among other examples. Additionally, the message format 600 may be configurable (e.g., may have a variable size, may have a variable quantity of bits).

In some cases, the message format 600 may include one or more elements 605, which may be examples of respective elements 205 as described with reference to FIG. 2. For example, the reserved bits, the candidate cell ID field, the TCI state quantity fields, the communication direction fields, and the TCI state ID fields may be examples of respective bits and fields described with reference to FIG. 2. The message format 600 may also include an element 605-c (e.g., a deactivation bit, an activation/deactivation bit). The element 605-e may indicate whether one or more TCI states (e.g., all TCI states) for one or more cells indicated by the element 605-f are deactivated or activated. For example, if the element 605-e (e.g., if a bit corresponding to the element 605-e) is set to a value of “1,” a UE 105 may deactivate all TCI states for one or more cells indicated by the element 605-f (e.g., indicated by one or more bits corresponding to the element 605-f). If the element 605-e is set to a value of “0,” the UE 105 may refrain from deactivating all TCI states for the one or more cells indicated by the element 605-f. When refraining from deactivating based on the element 605-e, the UE 105 may determine that TCI states provided by the MAC CE are to be activated. Thus, the element 605-e may be used to deactivate the previously activated TCI states (if any) or activate one or more TCI States.

The element 605-e may also control the formatting of the message format 600. For example, if the element 605-e is set to a value indicating deactivation (e.g., “1”), the one or more (or all) remaining octets of the message format 600 (e.g., octet 2 through octet N+3) may be omitted from the message format 600 or otherwise set to zero. Accordingly, a UE 105 may refrain from reading the remaining octets, which may conserve processing resources. In some other cases, a portion of the remaining octets may be omitted from the message format 600 if the element 605-e is set to the value indicating deactivation. For example, octets containing TCI state IDs may be omitted (e.g., octet 3 through octet N+3). In some cases, the network (e.g., a gNB 110) may configure the UE 105 to deactivate one or more (e.g., all) TCI states for all of the candidate cells based on the element 605-e. In some cases, the UE 105 may determine (e.g., without being configured by the network) that the element 605-e deactivates one or more TCI states (e.g., all TCI states) for all of the candidate cells. For example, the element 605-e being set to the value indicating deactivation may indicate that TCI states for a portion of candidate cells should be deactivated or that TCI states for all candidate cells should be deactivated.

In some cases, the element 605-e may deactivate one or more TCI states for cells (e.g., candidate cells) not indicated by the candidate cell ID field. For example, the MAC CE (e.g., the message format 600) may activate TCI states for one or more cells indicated by the candidate cell ID field and deactivate one or more TCI states for all other cells. If the element 605-e is not set or is set to a value indicating activation (e.g., “0”), a UE 105 may refrain from deactivating any TCI states. In some cases, deactivation of one or more TCI states may be implicitly indicated by a length field for the message format 600 (e.g., for the MAC CE). The length field may indicate a length of the message format 600 (e.g., a quantity of octets, a quantity of rows). In such cases, a UE 105 may receive a message that does not include an element 605-e, where the element 605-e is a reserved bit, or where the element 605-e is set to a value of “0.” The message may not include any TCI state ID fields (e.g., octet 3 through octet N+3 may be omitted). The UE 105 may then determine based on a length of the message (e.g., based on the octets included TCI state ID fields being omitted) that one or more TCI states should be deactivated (e.g., all previously activated TCI states should be deactivated or TCI states for cells not indicated by the candidate cell ID field should be deactivated).

In some cases, upon receiving configuration of one or more TCI states for LTM for one or more LTM candidate cell(s) the UE 105 may determine that (by default), the one or more TCI states configured for the LTM are deactivated (i.e., not activated). In an example, the UE 105 determines that TCI states for LTM, are deactivated (i.e., not activated) until activated. In some cases, the UE 105 may receive TCI state activation for one or more LTM TCI state(s). In some examples, the BWP of the LTM candidate cell for which the one or more TCI states are activated may be determined by the UE 105, if the BWP (identifier) is not explicitly provided by the activation message. The TCI State activation for a BWP of a candidate cell for which the TCI state activation applies may be determined to be the default BWP of the target candidate cell. Alternatively, the BWP of the LTM candidate cell for which the TCI state is activated may be determined by the UE 105 to be the BWP which is configured to be the first active downlink BWP (and/or uplink BWP) of the candidate cell (given e.g., in the candidate cell configuration). In yet another alternative, the BWP of the LTM candidate cell for which the TCI state is activated may be determined by the UE 105 to be the dedicated BWP of the candidate cell (e.g., a dedicated BWP with a lowest BWP ID). The first active BWP may mean the BWP that the UE 105 assumes to be active after cell switch (for uplink and/or downlink). The TCI state activation for a BWP of candidate cell for which the TCI state activation applies may be determined to be the default BWP of the target cell. The UE 105 may determine the BWP for which the TCI state is activated after applying the cell switch command or before the cell switch command.

In some cases, a new bit or field MAC CE (e.g., other than the element 605-e) may be utilized to indicate deactivation of one or more TCI states. For example, an (e)LCID field (e.g., a new (e)LCID field that identifies the MAC CE as being specific for LTM TCI state deactivation) may be utilized to indicate deactivation of one or more (e.g., all) TCI states. In some cases, the (e)LCID field may indicate that all TCI states associated with one or more cells should be deactivated. The one or more cells may include all candidate cells (e.g., having activated TCI states, all candidate cells indicated by one or more candidate cell ID fields) should be deactivated.

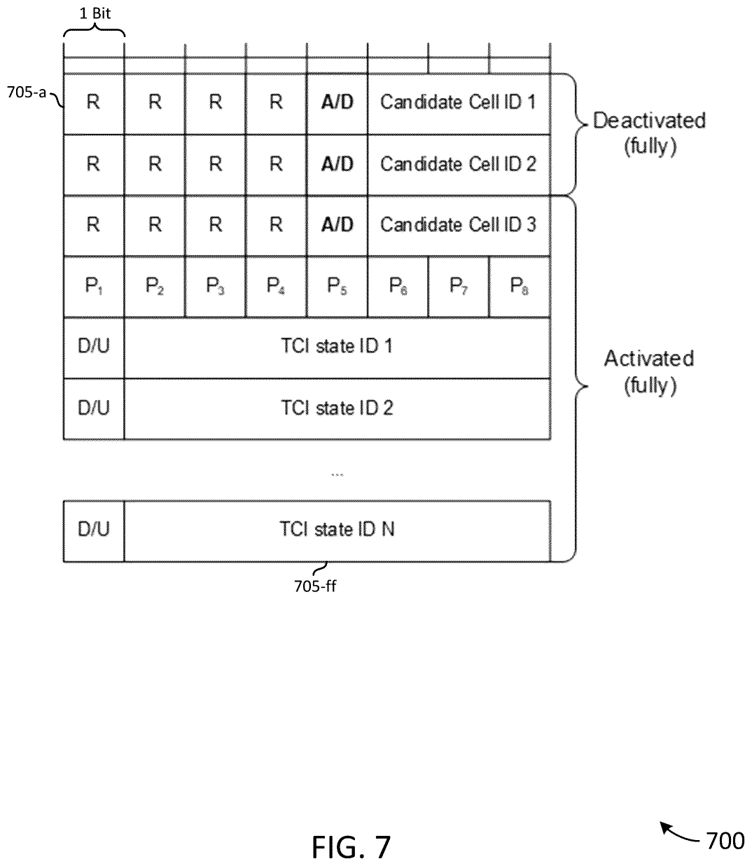

FIG. 7 illustrates an example of a message format 700 that supports TCI state deactivation and activation in accordance with examples described herein. The message format 700 may be an example of a MAC CE (e.g., a MAC CE format), which may include one or more elements 705. For example, the element 705-a, the element 705-b, the element 705-c, the element 705-d, the element 705-g, the element 705-h, the element 705-I, the element 705-j, the element 705-m, the element 705-n, the element 705-o, and the element 705-p may each correspond to or otherwise be examples of reserved bits (e.g., empty bits, bits that may not be currently utilized). The element 705-e, the element 705-k, and the element 705-q may each correspond to or otherwise be examples of activation/deactivation bits (e.g., bits that indicate activation or deactivation). The element 705-f, the element 705-1, and the element 705-r may each indicate or otherwise correspond to candidate cell ID fields. The number of candidate cell ID fields may be variable in the MAC CE format or configured/fixed in the format. The element 705-s, the element 705-t, the element 705-u, the element 705-v, the element 705-w, the element 705-x, the element 705-y, and the element 705-z may each indicate or otherwise correspond to TCI state quantity fields (e.g., P₁ through P₈). The element 705-aa, the element 705-cc, and the element 705-ee may each indicate or otherwise correspond to communication direction fields (e.g., indicating downlink, uplink, or both for a TCI state ID in a respective octet). The element 705-bb, the element 705-dd, and the element 705-ff may each indicate or otherwise correspond to TCI state identifiers IDs. Each element 705 may correspond to an octet, which may include respective rows of elements 705. Each element 705 may include or otherwise correspond to a quantity of bits. For example, the element 705-a may include one bit and the element 705-f may include three bits.

The message format 700 (e.g., the MAC CE) may be an illustrative example of a MAC CE utilized for activating or deactivating one or more TCI states. The message format 700 may be communicated (e.g., by a network entity, by a UE 105) to activate, request activation of, or indicate activation of one or more TCI states for one or more cells (e.g., one or more candidate cells). As shown, the message format 700 may include one or more activation/deactivation bits (e.g., the element 705-e, the element 705-k, the element 705-q), which may be utilized to indicate information for deactivating or activating one or more TCI states corresponding to respective candidate cell IDs (e.g., of a same octet as the respective activation/deactivation bit). The message format 700 may be identified by a subheader (e.g., a MAC subheader) (not shown). The subheader may include one or more elements 705 (e.g., one or more bits) that indicate information associated with the message format 700. For example, the subheader may include one or more LCID fields and one or more eLCID fields, among other examples. Additionally, the message format 700 may be configurable (e.g., may have a variable size, may have a variable quantity of bits).

In some cases, the message format 700 may include one or more elements 705, which may be examples of respective elements 205 as described with reference to FIG. 2. For example, the reserved bits, the candidate cell ID field, the TCI state quantity fields, the communication direction fields, and the TCI state ID fields may be examples of respective bits and fields described with reference to FIGS. 2 and 6. The message format 700 may also include activation/deactivation bits.

The activation/deactivation bits may indicate whether one or more TCI states (e.g., all TCI states) for one or more cells indicated by a respective candidate cell ID field are deactivated or activated. For example, if the element 705-e (e.g., if a bit corresponding to the element 705-e) is set to a value of “1,” a UE 105 may activate all TCI states for one or more cells indicated by the element 705-f (e.g., indicated by one or more bits corresponding to the element 705-f). If the element 705-e is set to a value of “0,” the UE 105 may deactivate all TCI states for the one or more cells indicated by the element 705-f. The message format 700 as shown in FIG. 7 may illustrate one example of a scenario where TCI states for candidate cell ID₁ and candidate cell ID₂ are deactivated and TCI states for candidate cell ID₃ are activated.

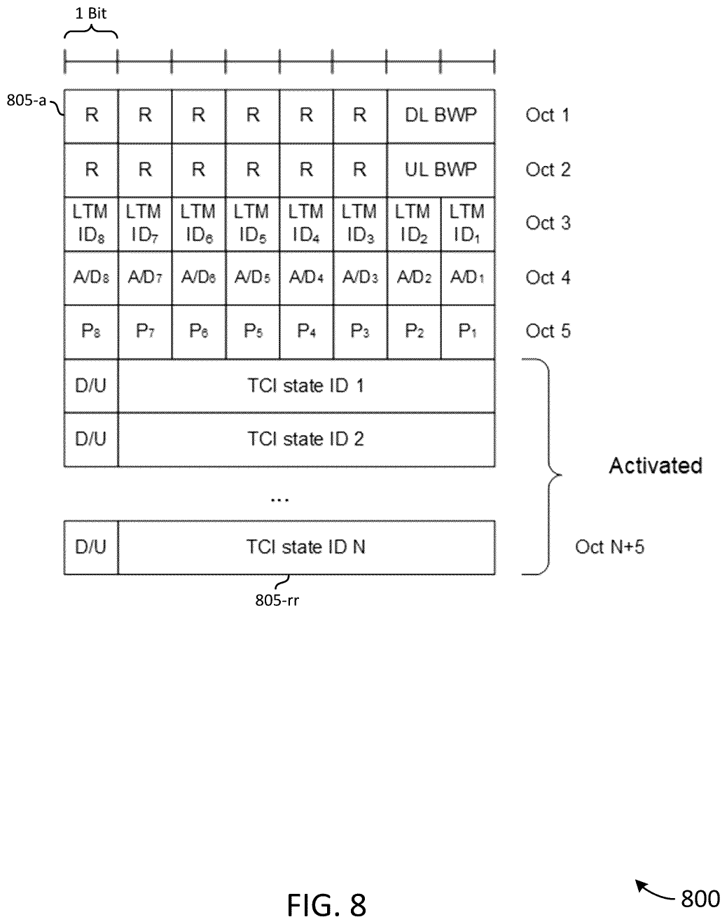

FIG. 8 illustrates an example of a message format 800 that supports TCI state deactivation and activation in accordance with examples described herein. The message format 800 may be an example of a MAC CE (e.g., a MAC CE format), which may include one or more elements 805. For example, the element 805-a, the element 805-b, the element 805-c, the element 805-d, the element 805-e, the element 805-f, the element 805-h, the element 805-I, the element 805-j, the element 805-k, the element 805-l, and the element 805-m, may each correspond to or otherwise be examples of reserved bits (e.g., empty bits, bits that may not be currently utilized). The element 805-g and the element 805-n may each correspond to or otherwise be examples of bandwidth part (BWP) bits. Each BWP bit may indicate information associated with a configuration for a bandwidth part. For example, the element 805-g may indicate one or more BWPs for downlink communications and the element 805-n may indicate one or more BWPs for uplink communications.

The element 805-o, the element 805-p, the element 805-q, the element 805-r, the element 805-s, the element 805-t, the element 805-u, and the element 805-v may correspond to or otherwise be examples of an LTM candidate cell ID bits. The element 805-w, the element 805-x, the element 805-y, the element 805-z, the element 805-aa, the element 805-bb, the element 805-cc, and the element 805-dd may correspond to or otherwise be examples of activation/deactivation bits (e.g., bits that indicate activation or deactivation of one or more TCI states). The element 805-ee, the element 805-ff, the element 805-gg, the element 805-hh, the element 805-ii, the element 805-jj, the element 805-kk, and the element 805-ll may each indicate or otherwise correspond to TCI state quantity fields (e.g., P₁ through P₈). The element 805-mm, the element 805-oo, and the element 805-qq may each indicate or otherwise correspond to communication direction fields (e.g., indicating downlink, uplink, or both for a TCI state ID in a respective octet). The element 805-nn, the element 805-pp, and the element 805-rr may each indicate or otherwise correspond to TCI state identifiers IDs. Each element 805 may correspond to an octet, which may include respective rows of elements 805. Each element 805 may include or otherwise correspond to a quantity of bits. For example, the element 805-a may include one bit and the element 805-g may include two bits.

The message format 800 (e.g., the MAC CE) may be an illustrative example of a MAC CE utilized for activating or deactivating one or more TCI states. The message format 800 may be communicated (e.g., by a network entity, by a UE 105) to activate, request activation of, or indicate activation of one or more TCI states for one or more cells (e.g., one or more candidate cells). As shown, the message format 800 may include one or more activation/deactivation bits, which may be utilized to indicate information for deactivating or activating one or more TCI states corresponding to one or more respective LTM candidate cell bits. The message format 800 may be identified by a subheader (e.g., a MAC subheader) (not shown). The subheader may include one or more elements 805 (e.g., one or more bits) that indicate information associated with the message format 800. For example, the subheader may include one or more LCID fields and one or more eLCID fields, among other examples. Additionally, the message format 800 may be configurable (e.g., may have a variable size, may have a variable quantity of bits). For example, the message format 800 may be configured to include only TCI state ID fields for LTM cell IDs that correspond to activation/deactivation bits that indicate a first logic value (e.g., corresponding to activation).

In some cases, the message format 800 may include one or more elements 805, which may be examples of respective elements 205, 505, and 705 as described with reference to FIGS. 2, 5, and 7. For example, the reserved bits, the TCI state quantity fields, the communication direction fields, the TCI state ID fields, the LTM cell ID bits, and the activation/deactivation bits may be examples of respective bits and fields described with reference to FIGS. 2, 5, and 7. The message format 800 may also include BWP bits, as described herein. The activation/deactivation bits may indicate whether one or more TCI states (e.g., all TCI states) for one or more cells indicated by a respective LTM candidate cell ID bit are deactivated or activated. For example, if the element 805-w (e.g., bit A/D₈) is set to a value of “1,” a UE 105 may activate all TCI states for one or more cells indicated by the element 805-o (e.g., LTM ID₈). If the element 805-w is set to a value of “0,” the UE 105 may deactivate all TCI states for the one or more cells indicated by the element 805-o. The message format 800 as shown in FIG. 8 may illustrate one example of a scenario where TCI states for LTM ID₁ through LTM ID₂ are activated, and thus the message format 800 includes corresponding TCI state ID fields (e.g., TCI state ID 1 through TCI state ID N).

In any of the example embodiments herein, a message that deactivates (and in some cases activates) one or more TCI states for one or more candidate cells, may comprise a field that refers to a specific bandwidth part (BWP). In an example, the deactivation of the TCI state or states may apply for the indicated BWP by the deactivation message.

In some cases, a gNB 110 may transmit (e.g., cause transmission of) a MAC CE to a UE 105. The MAC CE may indicate a candidate cell for the UE 105 to switch to. The UE 105 may then deactivate all TCI states for other candidate cells (e.g., all cells not indicated by the MAC CE). In some cases, the UE 105 may perform the deactivation based on a configuration for implicit deactivation of TCI states that are not indicated by a gNB. In some cases, the cells not indicated by the MAC CE may include one or more cells previously activated by the UE 105. In some cases, a MAC CE transmitted by a gNB 110 may include a global deactivation bit. If the global deactivation it is set to a first value (e.g., “1”), a UE 105 may deactivate TCI states of all cells not indicated by the MAC CE. In some cases, a beam indication may cause deactivation of one or more TCI states. For example, a beam indication may be transmitted to a UE 105 by a gNB 110 (e.g., prior to a cell switch command). Based on receiving the beam indication or based on information indicated by the beam indication, the UE 105 may deactivate one or more TCI states. In some cases, the beam indication may correspond to or otherwise indicate a specific TCI state of a cell. In such cases, a UE 105 that receives the beam indication may deactivate all TCI states for all cells not indicated by the beam indication (i.e., the beam indication indicates one or more TCI states associated with a specific cell). In some cases, a configuration may indicate whether a UE 105 deactivates one or more cells based on the beam indication. Some examples described herein refer to “TCI states,” which may be examples of LTM specific TCI states (e.g., TCI states for LTM operations). In some cases, a UE 105 may receive or may otherwise be configured with one or more serving cell TCI states (e.g., a serving cell TCI state list) and one or more LTM TCI states (e.g., an LTM TCI state list).

In one case, the UE 105 may indicate a capability or a preference for maximum number (e.g., M TCI states or M codepoints) of TCI states that can be activated. As an example, the UE 105 may have a limit how many TCI states it can track/monitor, thus it may limit the number of activate TCI states for the UE 105. The limit, M, may be a number of codepoints where each codepoint corresponds to a joint downlink and uplink TCI or separate TCI states (e.g., one codepoint may map to one joint TCI state. Alternatively, a codepoint may refer to separate downlink and uplink TCI states (i.e., two TCI states). The maximum number may be applied across all the configured candidate cells. In a further example the UE 105 may only keep the latest M TCI states (or codepoints) activated which may include TCI states from more than one candidate cell. In one example, the UE 105 may maintain up to M last activated TCI states as active. If M=8, and a first MAC-CE activates 8 TCI states for first candidate cell and second MAC-CE activates 4 TCI states for second candidate cell the UE 105 may determine to keep 4 TCI states of candidate cell 2 and only 4 TCI states of candidate cell 1 activated. The UE 105 may further determine to deactivate 4 TCI states for a first candidate cell. The deactivation selection may be based on the activation order of the TCI states (TCI states associated with codepoints) or based on L1 measurements (e.g., most recently measured/reported).

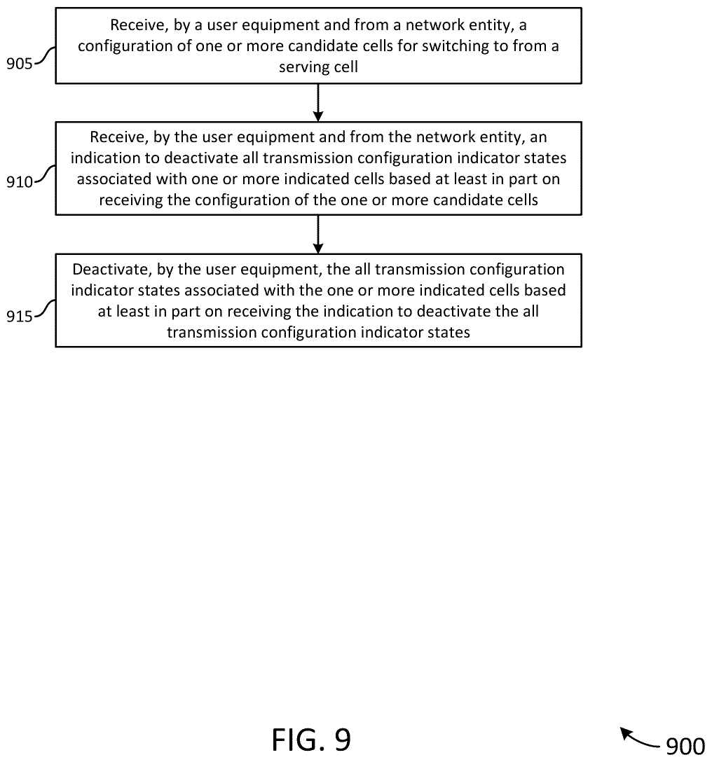

FIG. 9 illustrates an example of a flowchart 900 of the operations performed by an apparatus (e.g., an apparatus 400), such as may be embodied by a UE 105, or the like, as described with reference to FIGS. 1-8.

As shown in block 905, the apparatus may include means, such as the processing circuitry 405, the communication interface 415 or the like, for receiving, by a UE 105 and from a network entity, a configuration of one or more candidate cells for switching to from a serving cell.

As shown in block 910, the apparatus may include means, such as the processing circuitry 405, the communication interface 415 or the like, for receiving, by the UE 105 and from the network entity, an indication to deactivate all TCI states associated with one or more indicated cells based on receiving the configuration of the one or more candidate cells.

As shown in block 915, the apparatus may include means, such as the processing circuitry 405 or the like, for deactivating, by the UE 105, the all TCI states associated with the one or more indicated cells based on receiving the indication to deactivate the all TCI states. In accordance with examples described herein, any of the described operations may be performed multiple times or independently of other operations described herein.

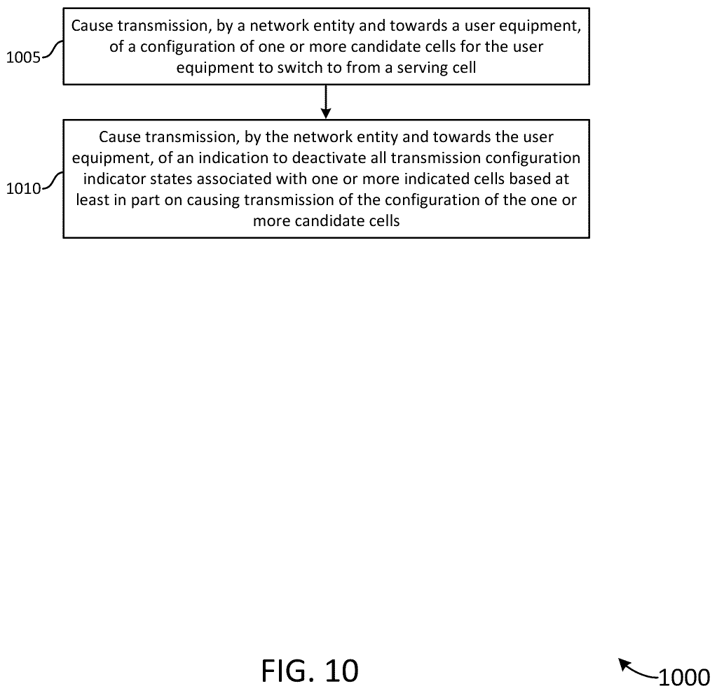

FIG. 10 illustrates an example of a flowchart 1000 of the operations performed by an apparatus (e.g., an apparatus 400), such as may be embodied by a network entity (e.g., a gNB 110), or the like, as described with reference to FIGS. 1-9.

As shown in block 1005, the apparatus may include means, such as the processing circuitry 405, the communication interface 415 or the like, for causing transmission, by a network entity and towards a UE, of a configuration of one or more candidate cells for the UE to switch to from a serving cell.

As shown in block 1010, the apparatus may include means, such as the processing circuitry 405, the communication interface 415 or the like, for causing transmission, by the network entity and towards the UE, of an indication to deactivate all TCI states associated with one or more indicated cells based on causing transmission of the configuration of the one or more candidate cells. It should be noted that any of the operations described herein may be performed multiple times or independently of other operations described herein.

FIGS. 9-10 illustrate flowcharts and signal flow diagrams depicting methods according to an example embodiment. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 410 of an apparatus 400 employing an example embodiment and executed by processing circuitry 405. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed is:

1. An apparatus comprising:
at least one processor; and
at least one memory storing instructions that, when executed by the at least one processor, cause the apparatus to at least perform:
receive, by a user equipment (UE) and from a network entity, a configuration of one or more candidate cells for switching to from a serving cell;
receive, by the UE and from the network entity, a medium access control (MAC) control element (MAC CE) that activates one or more transmission configuration indicator (TCI) states associated with at least one indicated candidate cell of the one or more candidate cells; and
deactivate, by the UE, all TCI states of one or more candidate cells not indicated by the MAC CE.

2. The apparatus according to claim 1, wherein one or more of: (i) the one or more candidate cells or (ii) the serving cell comprise the one or more indicated candidate cells.

3. The apparatus according to claim 1, wherein the instructions further configure the apparatus to:
activate, by the UE, one or more TCI states associated with a candidate cell of the one or more candidate cells based at least in part on receiving a command;
switch from the serving cell to the candidate cell of the one or more candidate cells; and
cause transmission, by the UE, of one or more messages using the one or more activated TCI states associated with the candidate cell.

4. The apparatus according to claim 1, wherein the MAC CE comprises:
a bitmap comprising a plurality of bits corresponding to the one or more indicated cells, wherein a bit of the plurality of bits indicates that the UE is to deactivate the all TCI states associated with a respective cell of the one or more indicated cells.

5. The apparatus according to claim 1, wherein the MAC CE comprises:
a bit for activating one or more TCI states or deactivating the all TCI states associated with the one or more indicated cells.

6. The apparatus according to claim 5, wherein a quantity of octets in the MAC CE is determined based at least in part on a value of the bit.

7. The apparatus according to claim 3, wherein the instructions further configure the apparatus to:
determine, by the UE, whether to read one or more octets of the MAC CE based at least in part on a value of the bit.

8. The apparatus according to claim 3, wherein the bit is further configured to activate one or more TCI states or deactivate the all TCI states, wherein a cell identifier field of the MAC CE indicates the one or more indicated cells.

9. The apparatus according to claim 1, wherein the MAC CE comprises:
a logical channel identifier field for deactivating the all TCI states.

10. The apparatus according to claim 1, wherein the MAC CE comprises:
an indication to deactivate the all TCI states and an indication to activate one or more TCI states associated with a candidate cell of the one or more candidate cells.

11. The apparatus according to claim 1, wherein the MAC CE comprises:
(i) a plurality of bits that indicate a plurality of cell identifiers and (ii) a plurality of bits that indicate whether respective previously activated TCI states are activated or deactivated.

12. The apparatus according to claim 1, wherein a bit of the MAC CE indicates that previously activated TCI states are to be deactivated by the UE.

13. The apparatus according to claim 1 wherein the MAC CE comprises:
an indication of a beam for a candidate cell of the one or more candidate cells.

14. The apparatus according to claim 1, wherein the instructions further configure the apparatus to:
refrain from performing one or more operations associated with the all TCI states based at least in part on the deactivating.

15. The apparatus according to claim 1, wherein the all TCI states are associated with cell switching from the serving cell to a candidate cell of the one or more candidate cells.

16. An apparatus comprising:
at least one processor; and
at least one memory storing instructions that, when executed by the at least one processor, cause the apparatus to at least perform:
cause transmission, by a network entity and towards a user equipment (UE), of a configuration of one or more candidate cells for the UE to switch to from a serving cell; and
cause transmission, by the network entity and towards the UE, of a medium access control (MAC) control element (MAC CE) that activates one or more transmission configuration indicator (TCI) states associated with at least one indicated candidate cell of the one or more candidate cells;
wherein the UE deactivates all TCI states of one or more candidate cells not indicated by the MAC CE.

17. The apparatus according to claim 16, wherein one or more of: (i) the one or more candidate cells or (ii) the serving cell comprise the one or more indicated candidate cells.

18. The apparatus according to claim 16, wherein the instructions further configure the apparatus to:
receive, from the UE, one or more messages using one or more TCI states associated with a candidate cell of the one or more candidate cells.

19. The apparatus according to claim 16, wherein the instructions further configure the apparatus to:
receive, from the UE, one or more messages using one or more TCI states associated with the serving cell.

20. The apparatus according to claim 16, wherein the all TCI states are associated with cell switching from the serving cell to a candidate cell of the one or more candidate cells.
